(19) United States
(12) Patent Application Publication
(10) Pub. No.: US 2023/0409996 A1
(43) Pub. Date: Dec. 21, 2023

(54) METHOD AND APPARATUS FOR RETRIEVING RELEVANT RECORDS FROM A DATABASE USING PREDICTION MODELS

(71) Applicant: Lynk Global, Hong Kong (HK)

(72) Inventors: Peggy Choi, Kowloon (HK); James Lin, Princeton Junction, NJ (US); Koushik Pal, Ontario (CA); UdayaKrishna Bandaru, Tamil Nadu (IN)

(21) Appl. No.: 17/749,778

(22) Filed: May 20, 2022

(51) Int. Cl. G06Q 10/06; G06F 16/2457

(52) U.S. Cl. CPC G06Q 10/063112; G06F 16/24578

(57) ABSTRACT

A computer-implemented method and a computer system for retrieving relevant records from a database. A project request is received from a user device over a computer network, the project request including a description of a project for which an expert consultation is desired. The request is parsed for categories and keywords. Relevant prediction models are determined based on the categories, each of the plurality of prediction models being based on a different aspect of expert search. Each of the relevant prediction models is applied to at least one of the keywords to obtain search criteria that is used to query the database.

### BACKGROUND

Search engines have become ubiquitous in information technology. The most widely known search engine is the GOOGLE™ search engine that indexes web content and provides a user interface through a web browser to allow users to search for relevant web content based on keywords. Other more specialized search engines associated with databases are also well-known. For example, a search engine can be associated with database that is dedicated to the search of specific data in the database. Such search engines can be optimized for dealing with specific data in the database that may be long, semi structured, or unstructured. Further such search engines typically offer specialized methods such as full-text search, complex search expressions, and ranking of search results.

It has become almost essential to provide complex search capabilities with any collection of data, whether it be a catalog of digital content (e.g., music), scientific data, or any other type of specialized data. In most database search applications, the data is indexed, i.e., tables are created in format that indicates likely search attributes to optimize potential searches. However, indexing requires anticipating the most likely search attributes.

Recently, the use of “predictive queries” and predictive models has become known for providing answers to queries. Predictive modeling is a well-known statistical technique that leverages machine learning and data mining to predict and forecast likely future outcomes with the aid of historical and existing data. It works by analyzing current and historical data and projecting what it learns on a model generated to forecast likely outcomes. Predictive queries are similar to conventional database queries. However, predictive queries provide predictions about the unknown. One example of predictive queries is incorporated in BayesLite, a probabilistic database built on SQLite 3. While the use of predictive models has improved data retrieval in many applications, predictive models are, by nature, very specific and thus difficult to implement for data retrieval in many complicated and multi-dimensional tasks, such as searching for individuals having desired experience and skills.

### SUMMARY OF THE INVENTION

Disclosed implementations leverage multiple distinct predictive models and a novel data model to provide searching and data retrieval in complex multi-dimensional databased implementations. One example of such a multi-dimensional database implementation is the creation and searching of data related to persons having specific skills and experience. Such capability is based on many factors, such as education, work experience, employer, specific projects, relationships, and the like. Further, queries may include many different parameters related to each of these factors. Finally, the very nature and complexity of expertise makes it difficult for a user to formulate accurate and efficient queries. The disclosed implementations select multiple predictive models based on a user request and formulate queries to be input into the predictive models based on the request. The disclosed implementations provide improved database creation, searching, and data retrieval.

A first aspect of the invention is a computer-implemented method for retrieving relevant records from a database, wherein the records include information about skills and experiences of experts in specific fields of endeavor, the method comprising: receiving a project request from a user device over a computer network, the project request including a description of a project for which an expert consultation, or other expert services such as project work and general engagements, is required; parsing the project request for categories and keywords; determining at least two relevant prediction models, from a plurality of prediction models, that are relevant to the categories, each of the plurality of prediction models being based on a different aspect of expert search; independently applying each of the relevant prediction models to at least one of the keywords to obtain search criteria; querying the database with a search query based on the search criteria; retrieving matching records from the database that match the search query; and ranking the matching records based on relevance to the project request.

A second aspect of the invention is a computer-implemented method for enhancing data records in an expert database, wherein the records include information about skills and experience of experts in specific fields of endeavor, the method comprising: parsing a record in the expert database that includes information about an expert in at least one specific field of endeavor; selecting a taxonomy directed to a business aspect relevant to the at least one specific field of endeavor wherein the taxonomy is used to generate keywords; creating search criteria including the keywords and an identity of the expert querying at least one external database based on the search criteria; retrieving matching records from the at least one external database that match the search criteria; and enhancing the record in the expert database with information contained in the matching records.

Additional aspects of the invention include computer systems and data structures for accomplishing the methods described above.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative embodiments. It should be understood, however, that the invention is not limited to the precise arrangements and instrumentalities shown. In the drawings:

FIG. 1 is an architecture diagram of a computing system in accordance with disclosed implementations.

FIG. 2 is a schematic flow diagram of a search procedure in accordance with disclosed implementations.

FIG. 3 is a schematic flow diagram of a process for enhancing a database in accordance with disclosed implementations.

FIG. 4 is a schematic diagram of a data model in accordance with disclosed implementations.

### DETAILED DESCRIPTION

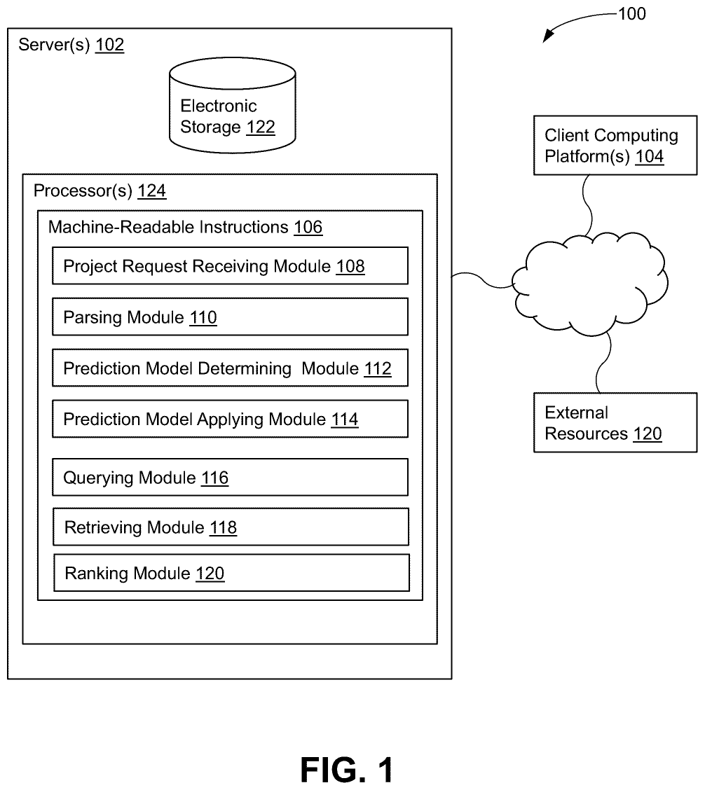

FIG. 1 illustrates a system 100 configured for searching a database, in accordance with one or more implementations. In some implementations, system 100 may include one or more servers 102. Server(s) 102 may be configured to communicate with one or more client computing platforms 204 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. Client computing platforms include the viewing devices and mobile devices described below. Server(s) 102 and client computing platform(s) 104 can communicate with external resources 120 which are described below.

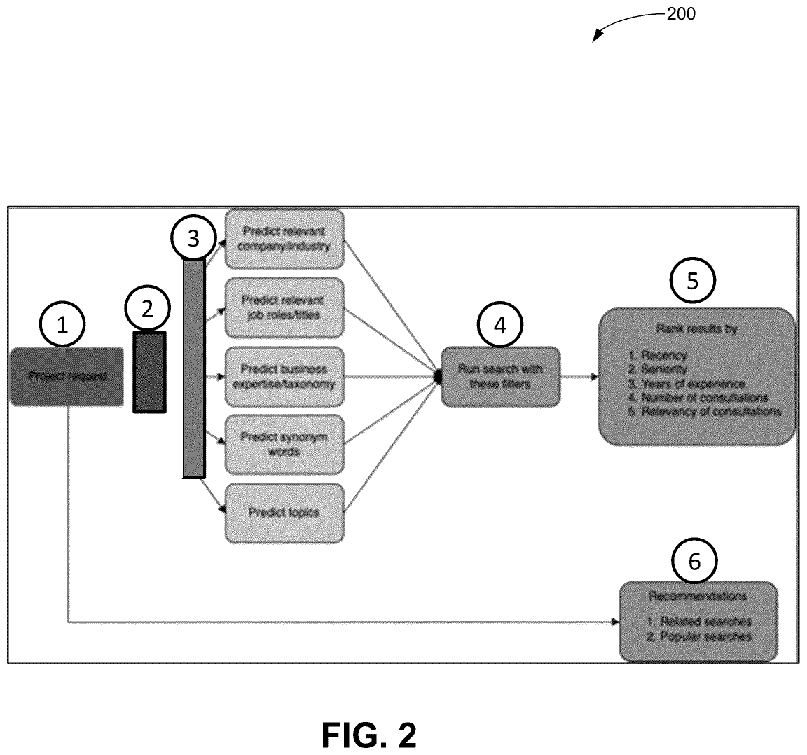

Server(s) 102 may be configured by machine-readable instructions 106. Machine-readable instructions 106 may constitute one or more modules. The modules may include computer program portions executed by one or more computer processors. The modules may include one or more of a project request receiving module 108, parsing module 120, prediction model determining module 112, prediction model applying module 114, querying module 116, receiving module 118, and ranking module 120. The function of each module will be described in detail below with respect to FIGS. 1 and 2.

FIG. 2 is a schematic illustration of a workflow 200 in accordance with an example method of the disclosed implementations. At 1 in FIG. 2, a project request is created. For example, the project request can be created by a user through a user interface of a client computing platform 104. The project request is a data structure specifying parameters of a data retrieval request. In this example, the project request is a request for identifying one or more experts having specified skills in a particular field of endeavor and for retrieving information relating to the expert(s). For example, the project request can originate from a user device over a computer network and can include a description of a project for which an expert consultation is desired.

At 2, the project request is parsed to ascertain categories and keywords associated with the project. The categories and keywords can include words parsed directly from the project request or can be ascertained by various processing techniques. Accordingly, the word “parse” as used herein includes determining the resulting keywords and categories in various ways. For example, the keywords and categories can be determined by comparing the project request to one or more predetermined schemas or through any known mechanism for language processing. Topic detection, topic modeling, or topic extraction processes are known machine learning techniques that can be used to categorize content. Such techniques can be applied to the project request. Two common approaches for topic analysis with machine learning are NLP Topic Modeling and NLP Topic Classification. In a simpler example, the project request expressly includes topics selected from a predetermined schema.

At 3, at least one prediction model that is relevant to the categories are determined from among a plurality of prediction models. Each of the plurality of prediction models can be directed to a different aspect of an expert search. For example, the prediction models can include a company and industry prediction model, a job role and title prediction model, a business expertise taxonomy prediction model, a synonym prediction model, and a category/topic prediction model. After the relevant prediction models are determined based on the categories, each of the relevant prediction models are independently applied to at least one of the keywords to obtain search criteria and an expert database is queried based on the search criteria to obtain matching records, at 4. The search criteria can include one or more filters resulting from the processing by each relevant prediction model. The search query processing can be accomplished in any well-known manner. The matching records are retrieved and ranked based on relevance to the project request at 5. At 6, related search queries can be recommended to a user based on historical data in a known manner. For example, node embeddings from a knowledge graph data model can be used to find similar experts. Further, historical data relating to the search query can be used to update at least one of the prediction models, so that previous search queries can be used to supplement subsequent search queries. The ranking can be accomplished based on various criteria such as:
Relevance of consultations;
Recency of relevant consultations;
Number of consultations;
Recency of relevant job experience;
Seniority of current job experience;
Years of experience; and or
Relevant companies work experience.

A simple example of applying the prediction models of step 3 of FIG. 2 is described below. Suppose a client is interested in obtaining expert advice about the sales and business opportunities of electric vehicles. Once topic parsed from the project description can be “electric vehicles” The company prediction model will provide company filters (e.g., Tesla, GM, . . . ). The job title prediction model will predict which job titles are relevant to this requirement (e.g., VP Sales, Director Marketing, . . . ). The business expertise taxonomy will predict which business taxonomies are relevant to the requirement (e.g., Marketing & Sales, Marketing Strategy, Marketing Management & Operations, . . . ). Any other relevant prediction models will accomplish similar tasks. These predictions are all independent of each other and can be run in parallel. Finally, the filters generated by the prediction models will be applied to a search. In this simple example, some of the filters, such as relevant companies, are intuitive. However, in more complex and esoteric areas of expertise, which are often the subject of an expertise search, the prediction models and the method of using the same becomes more valuable.

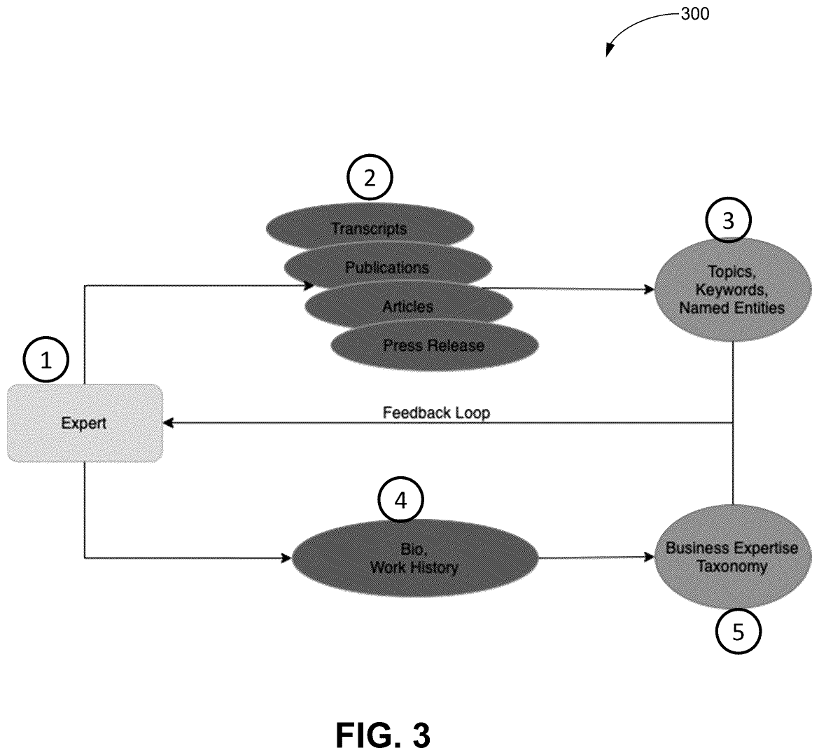

As noted above, an expert database is queried. Of course, the more complete and more accurate the database, the more relevant the search results. FIG. 3 illustrates a workflow 300 for enhancing the records of the expert database. At 1, an existing record corresponding to, for example, a person with a specified set of expertise (an “expert”) is read to obtain information about the expert. For example, the information can include the expert's name, company of employment, previous employers, and areas of expertise. At 2, this information is used to query various databases for relevant documents such as consultations transcripts, press releases and publications about and authored by the expert. Keywords can be extracted from the query results at 3 and fed back to the expert database to enhance the database record corresponding to the expert. For example, the existing record may indicate that the expert has experience in electrical engineering, but articles authored by the expert may relate to electric vehicles. In this case, expertise relating specifically to electric vehicles can be added to the record. At 4, the information from the existing record that relates to the expert's work history can be extracted and applied to an expertise taxonomy, at 5, to provide additional descriptors of the expert's expertise. These descriptors can also be fed back to the database record corresponding to the expert.

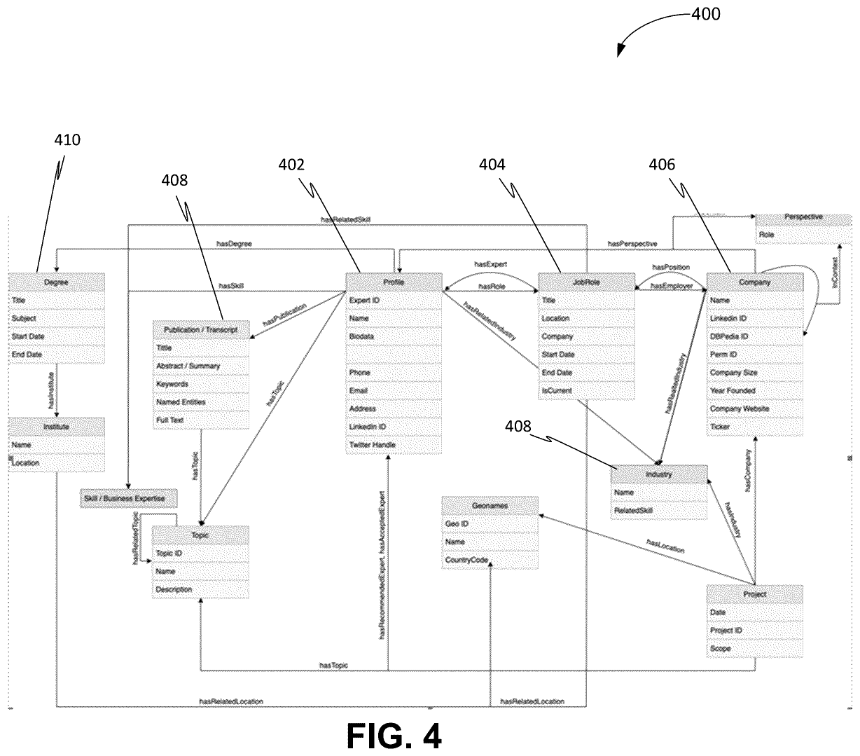

FIG. 4 illustrates an example of a data model 400 of the expert database. The data model includes various elements, each expressed as data structures, that are linked to one another in novel ways. Profile element 402 is linked to various elements relating to experience of the person(s) of profile element 402. These elements include job role element 404, company element 406, and industry element 408. Profile element 402 is also linked to various elements relating to skill sets of the person(s) of profile element 402. These elements include publication/transcript element 408 and educational degree element 410. Each element is linked to other elements as shown. For example, the hasperspective link goes from company element 406 to profile element 402. This allows for finding relevant experts that have specific perspective, for example competitor or supplier, on the searched companies. Further, a feedback loop can be employed whereby when information relating to an expert is discovered, the newly discovered information can be parsed and used as training inputs for the predictive models.

A given client computing platform 104 may include one or more processors configured to execute computer program modules. The computer program modules associated with the given client computing platform 104 allow the client computing platform to interface with system 100 and/or external resources 120, and/or provide other functionality attributed herein to client computing platform(s) 104. By way of non-limiting example, the mobile device of a given client computing platform 104 may include one or more of a desktop computer, a laptop computer, a handheld computer, a tablet computing platform, a NetBook, a Smartphone, a gaming console, and/or other computing platforms. The viewing device of a given client computing platform can be the same device as the mobile device or can be a separate device and can include one or more of a desktop computer, a laptop computer, a handheld computer, a tablet computing platform, a NetBook, a set-top box, a television, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100. For example, external resources 120 can include various sources of information relevant to expertise, such as databases corresponding to industry publications, universities, social networks, and the like.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 202, information received from client computing platform(s) 104, and/or other information that enables server(s) 202 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute the function of the modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed:

1. A computer-implemented method for retrieving relevant records from a database, wherein the records include information about experts in specific fields of endeavor, the method comprising:
receiving a project request from a user device over a computer network, the project request including a description of a project for which an expert is desired;
parsing the project request for categories and keywords;
determining at least two relevant prediction models, from a plurality of prediction models, that are relevant to the categories, each of the plurality of prediction models being based on a different aspect of expert search;
independently applying each of the relevant prediction models to at least one of the keywords to obtain search criteria;
querying the database with a search query based on the search criteria;
retrieving matching records from the database that match the search query; and
ranking the matching records based on relevance to the project request.

2. The method of claim 1, wherein the project request includes desired skills of the expert and the ranking is based on one or more of the following factors of an expert indicated by the fields in the record;
relevant consultations;
timing of relevant consultations;
number of relevant consultations;
relevant job experience;
timing of relevant job experience;
seniority of current job;
years of relevant experience; or
work experience with relevant companies.

3. The method of claim 1 wherein the plurality of prediction models include;
a Company and Industry prediction model;
a job role and title prediction model;
a business expertise taxonomy prediction model;
a synonym prediction model; and
a topic prediction model.

4. The method of claim 3, wherein the business expertise taxonomy prediction model is operative to select a taxonomy directed to a business aspect relevant to the project request and wherein the taxonomy is used to generate keywords and phrases that are included in the search criteria.

5. The method of claim 1, wherein each of the relevant prediction models generate at least one filter that is used as the search criteria.

6. The method of claim 1, further comprising:
storing historical data relating to the search query; and
updating at least one of the prediction models based on the historical data whereby previous search queries can be used to supplement subsequent search queries.

7. The method of claim 6, further comprising recommending related search queries to a user based on the historical data.

8. A computer-implemented method for enhancing data records in an expert database, wherein the records include information about experts in specific fields of endeavor, the method comprising:
parsing a record in the expert database that includes information about an expert in at least one specific field of endeavor
selecting a taxonomy directed to a business aspect relevant to the at least one specific field of endeavor wherein the taxonomy is used to generate keywords;
creating search criteria including the keywords and an identity of the expert
querying at least one external database based on the search criteria;
retrieving matching records from the at least one external database that match the search criteria; and
enhancing the record in the expert database with information contained in the matching records.

9. The method of claim 8, wherein the at least one external database is remote from the expert database and includes at least one of transcripts, publications, articles and press releases.

10. A computer system for retrieving relevant records from a database, wherein the records include information about experts in specific fields of endeavor, the system comprising:
at least one processor; and
at least one memory storing instructions, which when executed by the at least one processor cause the at least one processor to carry out steps comprising:
receiving a project request from a user device over a computer network, the project request including a description of a project for which an expert is desired;
parsing the project request for categories and keywords;
determining at least two relevant prediction models, from a plurality of prediction models, that are relevant to the categories, each of the plurality of prediction models being based on a different aspect of expert search;
independently applying each of the relevant prediction models to at least one of the keywords to obtain search criteria;
querying the database with a search query based on the search criteria;
retrieving matching records from the database that match the search query; and
ranking the matching records based on relevance to the project request.

11. The system of claim 10, wherein the project request includes desired skills of the expert and the ranking is based on one or more of the following factors of an expert indicated by the fields in the record;
relevant consultations;
timing of relevant consultations;
number of relevant consultations;
relevant job experience;
timing of relevant job experience;
seniority of current job;
years of relevant experience; or
work experience with relevant companies.

12. The system of claim 10 wherein the plurality of prediction models include;
a Company and Industry prediction model;
a job role and title prediction model;
a business expertise taxonomy prediction model;
a synonym prediction model; and
a topic prediction model.

13. The system of claim 12, wherein the business expertise taxonomy prediction model is operative to select a taxonomy directed to a business aspect relevant to the project request and wherein the taxonomy is used to generate keywords and phrases that are included in the search criteria.

14. The system of claim 10, wherein each of the relevant prediction models generate at least one filter that is used as the search criteria.

15. The system of claim 10, wherein the steps further comprise:
storing historical data relating to the search query; and
updating at least one of the prediction models based on the historical data whereby previous search queries can be used to supplement subsequent search queries.

16. The system of claim 15, wherein the steps further comprise recommending related search queries to a user based on the historical data.

17. A computer system for enhancing data records in an expert database, wherein the records include information about experts in specific fields of endeavor, the system comprising:
at least one processor; and
at least one memory storing instructions, which when executed by the at least one processor cause the at least one processor to carry out steps comprising:
parsing a record in the expert database that includes information about an expert in at least one specific field of endeavor selecting a taxonomy directed to a business aspect relevant to the at least one specific field of endeavor wherein the taxonomy is used to generate keywords;
creating search criteria including the keywords and an identity of the expert
querying at least one external database based on the search criteria;
retrieving matching records from the at least one external database that match the search criteria; and
enhancing the record in the expert database with information contained in the matching records.

18. The system of claim 16, wherein the at least one external database is remote from the expert database and include at least one of transcripts, a publications, articles and press releases.
